(19) United States
(12) Patent Application Publication
(10) Pub. No.: US 2008/0098316 A1
(43) Pub. Date: Apr. 24, 2008

(54) User Interface for Browsing Image

(75) Inventor: Kelly Patrick Declan, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,089

(22) PCT Filed: Jan. 16, 2006
(86) PCT No.: PCT/IB06/50138

§ 371 Date: Jul. 17, 2007

(30) Foreign Application Priority Data
Jan. 20, 2005 (CN) 200510002529.8

(51) Int. Cl. G06F 3/048

(52) U.S. Cl. 715/764

(57) ABSTRACT

This invention discloses an image search and display system that includes a graphic user interface to provide to a user with visual display of three-dimensional selections of location, time and people to navigate pictures. The location and time will be presented on a distorted map and timeline respectively, where the distortion is based on the number of pictures at a certain location or period of time. The thumbnails of people are sized according to the number of pictures including the relevant persons, and this will typically result in the owner of the content and close family/friends having the largest thumbnails. Also the user interface can group the people according to the number of pictures they have in common.

### FIELD OF THE INVENTION

This invention relates to systems for processing a video and graphic image. More particularly, this invention relates to a user interface and method for intuitively and conveniently searching and comparing a large collection of images.

### BACKGROUND OF THE INVENTION

As users collect more and more digital photographic images, e.g. 10,000 photos in a collection, navigating through this collection becomes ever more difficult. Unless prior human efforts are applied to properly organize the pictures, finding a group of photographic pictures related to specific time, people or locations might become a time consuming process. Many patents and patent applications have disclosed some systems and methods to enhance the browsing and searches of pictures. However, these methods and user interface systems do not provide a graphic user interface (GUI) that would enable a picture browser to intuitively take the displayed graphs as a guideline for selecting location, time and people. In order to find a particular picture, a browser of photograph pictures must navigate through multiple database entries and read image display selections to find and select the desired pictures.

In Japanese Patent Application 2003-085530, a display device and method are disclosed to simplify the browsing and management of display of data. In the display device, a central processing unit is employed to obtain image data, photographic time data and memory utilization data from an external memory. A display part displays a clock type data list showing twenty four hours and a pointer for selecting the image data, and displays the memory utilization data obtained from the external memory of a digital camera and thumbnail data for developing and contracting the image data on the clock type data list. The CPU magnifies and displays the selected thumbnail data.

In United States Patent Application 20030033296, an invention for creation of and storage of digital images in database for archiving, cataloguing, searching and retrieving over network is disclosed. The method includes a step of constructing query for receiving collection of digital image objects. The pictures can be displayed on a timeline or map.

Other prior art disclosures include EP1429287 that provides thumbnail manipulation, and hierarchical coding/encoding and image based file browsing with a method to zoom into photographs. EP1338960 provides a calendar based user interface system for managing photographic pictures. US Patent Application 20020075310 discloses a graphic user interface adapted to allow scene content annotation of groups of pictures in a picture database to promote efficient browsing of graphs in the database.

These prior art disclosures however do not provide an effective solution to the difficulties that a browser of photographic pictures still must navigate through many databases entries and read many image display selections to find a picture due to the facts that the graphic user interface systems do not provide intuitive selections and operations.

For the above reasons, there is a need to provide new and improved system configurations and functional processing procedures to simplify the operations and selections of users browsing through a large number of photographic pictures. It is desirable that the graphic user interface can provide intuitive user selection related to the time, location, people or other selection options directly related to the image contents included in each of the photographic pictures. It is further desirable that such selection options provided for users are displayed as visible and intuitive images to allow a user to directly make such selections so that the above-discussed problems and limitations can be overcome.

### OBJECT AND SUMMARY OF THE INVENTION

It is therefore an object of the present invention to provide a new and improved user interface with visual display such as location, time and people to enable a picture browser to intuitively and conveniently navigate and search for a specific picture related to the contents, time and location of the specific picture.

Specifically, this invention discloses a photo-browsing interface constructed based on the meta-data of location, time and people as a classifying index to make it easier to find photos of interest.

In a specific embodiment, a user is provided with visual display of three-dimensional selections of location, time and people to navigate pictures. The location and time will be presented on a distorted map and timeline respectively where the distortion is based on the number of pictures at a certain location or period of time. The visual display of people will be presented with thumbnails of people sized according to the number of pictures wherein these people are photographed. This will typically result in a group of photos of the owner of the content and close family/friends having the largest thumbnails. Also the people can be grouped according to the number of pictures they have in common.

In this way, the display of the graphic user interface is presented in a distorted way based on the content itself. The graphic user interface thus helps the user to navigate and search the pictures. Furthermore, in order to facilitate navigation, the groups of images with the most pictures are proportionally magnified in space and time. Similarly, the people with the most pictures are magnified in the presentation. For the display of the graphs, it is not necessary to explain to the user the specific grouping method, because the meaning displayed by the graphs will be clear to the user only having a look when the user browses and searches for the picture selection, therefore to provide a clear and intuitive search interface.

Briefly, in a preferred embodiment, the present invention discloses an image search and display system for processing a plurality of images tagged with data related to contents of the images and circumstances in forming said images. The image search and display system includes a graphic user interface for displaying a user-selectable graphic element for providing a pointer to the contents of the images or the circumstances in forming the images to make the user capable of intuitively searching the images. In another preferred embodiment, the user-selectable graphic element includes a map with a plurality of magnified portions at a plurality of locations on the map, which are magnified with a magnification ratio proportional to the number of images related to each of the locations for providing pointers for the user to point to the selected location where the image is taken. In another preferred embodiment, the user-selectable graphic element includes a time-line with a plurality of time point indications on the time-line, the length between the time point indications being proportional to the number of the images related to a time period between the time point indications for providing the user with a pointer to point to the selected time when the image is taken. In another preferred embodiment, the user-selectable graphic element includes a plurality of images each showing a group of people as the user-selectable pointer to point to the selected group of persons included in the contents of the images wherein each of the images is magnified with a magnification ratio proportional to the number of the photos of certain person included in each of the images of persons.

These and other objects and advantages of the present invention will become obvious to those skilled in the art after reading the following detailed description of the preferred embodiments with reference to the drawings.

### BRIEF DESCRIPTION OF THE DRAWINGS

FIG. 1 shows a screen display of three tags for a user to select location, time, or people, allowing the user to browse and search a picture by selecting location, time or people;

FIG. 2 is a screen display of a distorted magnification of a map for user to select and search a picture taken at a particular location;

FIG. 3 is a screen display of a distorted time line for user to select and search a picture taken at a particular time;

FIG. 4 is a screen display of thumbnails of different sizes for showing images of different persons according to the number of pictures that has some person in the pictures;

FIG. 5 is a screen display of thumbnails automatically organized according to group of people included in the pictures, to facilitate a user to search for a picture according to the group of people.

### DETAILED DESCRIPTION OF THE INVENTION

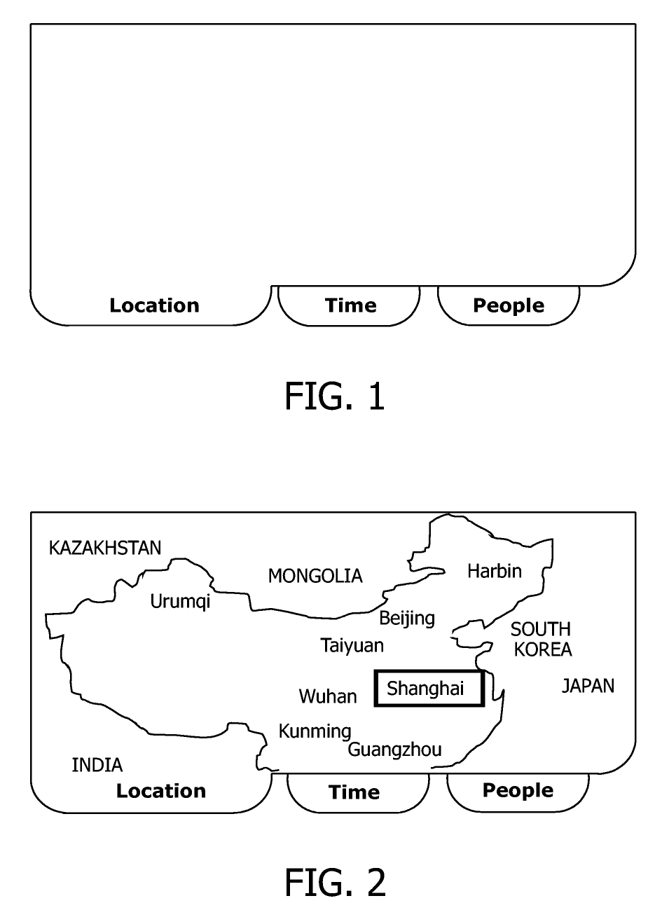

FIG. 1 shows a graphic user interface of an image search and display system, which includes three tags, i.e., location, time and people tags as shown in FIG. 1 to enable a user, according to the tags, to identify and search through multiple images to select a picture related to a location, time and people. Each of these tags, i.e., location, time, and people tags shown in FIG. 1, is served in function as a filter to exclude all the images which are not relevant to the location, time and people selected by the user. Specifically, all digital images contain meta data of time and location; these meta data have contained location data of GPS coordinates, and time data, e.g., date and time of the day when the picture is taken are stored. The names of the persons included in the digital images may also be stored for enhancing the search and display of the digital images. An intuitive user interface to allow for easy navigation in the picture search process can be provided by linking the data, when a user clicks a special thumbnail to select a type of the searches, e.g., using the location, time or persons included in the pictures.

FIG. 2 is a display of a map on the image search and display system after the user clicks the location selection tag. The map as shown may be provided to cover the whole world or a more limited region depending on the extent of location covered by the images under search. Once the location tag is selected, the system will show a distorted map with some parts magnified. The parts chosen to be magnified will be locations where a large number of pictures were taken and the magnified size will reflect the number of the pictures. Typically those maps display some locations where users have taken a large number of pictures, e.g. their hometown or a particular location visited during a vacation. In these locations the map will be magnified so the user can quickly see more details for these locations and easily distinguish photos taken in different places. In general, for locations with a small number of pictures, the user doesn't care to navigate based on specific places within a city, whereas for a city with a large number of pictures (i.e. a location that the user knows well) the user will navigate based on specific places within that city as shown in FIG. 2. In the case of a touch screen, the user can simply circle to select the group of pictures of particular interest.

FIG. 2 shows a very simple representative example. In general the magnified area may or may not appear as a discrete overlay as shown. The magnified portion may alternately be displayed as a smooth magnification of or a part distortion of the map. The non-magnified parts will be squeezed. Also FIG. 2 shows only a single location (Shanghai) magnified, the normal display may include multiple locations magnified to different levels. The map may include special symbols, e.g., a red dot, to indicate the locations of photos so the user can quickly see the locations with photos. The system will also provide the user an option function to magnify the map, with the existing distorted magnification preserved while having magnified a whole map.

In addition to a selected portion of the magnified map as discussed above, the search and display system can also use colors to indicate the areas with the most pictures in a manner similar to that the colors are used on maps to indicate the height above sea level.

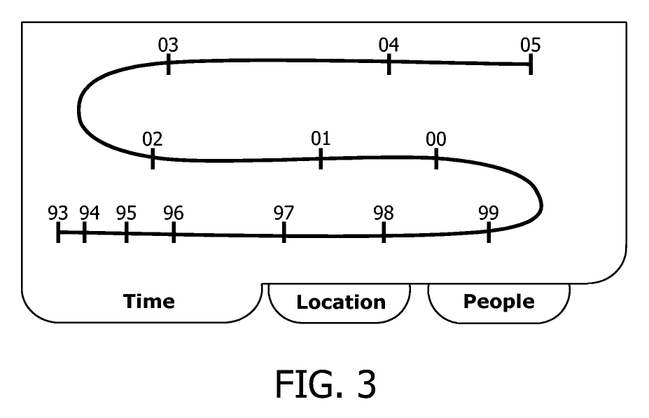

FIG. 3 shows a distorted time line displayed on the image search and display system of this invention when a user clicks the time tag. On the distorted time line, periods with a large number of pictures are given a longer segment of timeline. As the users normally want to see image details for the periods with the most pictures, the display of such periods is most helpful for the search and display of the user. FIG. 3 shows a one-dimensional magnified time line. A two dimensional version can also show distribution over days (along the bottom) and time of day (along the side axes). On both the map and the time-line, colors can also be used to highlight the places or time with the highest density of pictures, e.g. bright red for the densest parts. Alternatively, brightness can be used, that is, colors do not change but most dense parts look brighter on either the map or the distorted time line.

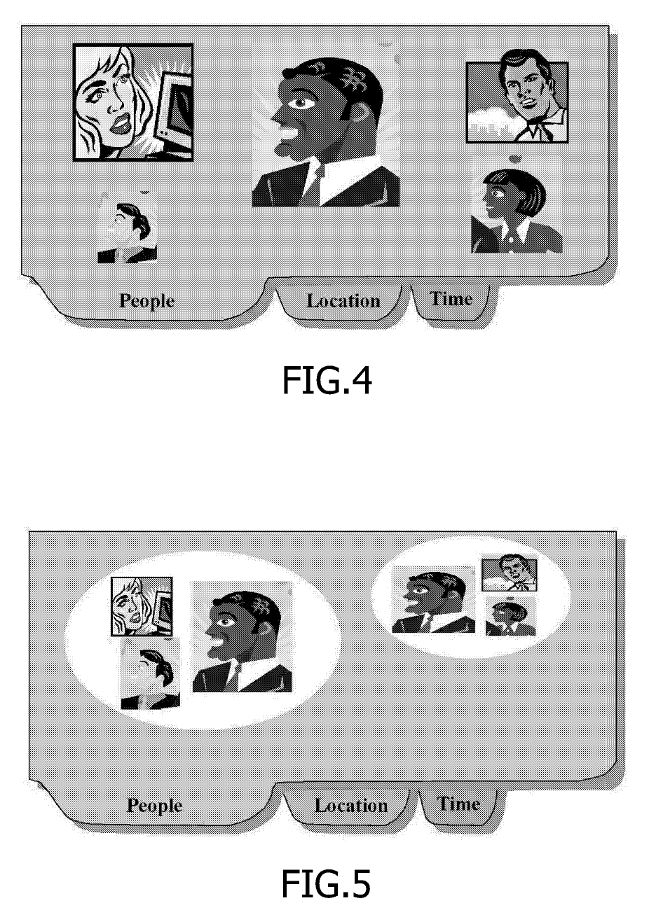

FIG. 4 shows an exemplary display of thumbnails of a person in the picture when a user clicks a people tag. The size of the thumbnails is proportional to the number of pictures that include that person (up to a maximum size), thus the user can find the most frequently occurring people quickly, e.g., the close family members and friends of the photographer. Furthermore, the pictures can be grouped based on the people appearing in the same pictures, i.e. if there are a large number of pictures each containing the same set of people, then this set of pictures can be grouped as a specified set. Some people, e.g., the owner of the content may appear in multiple groups. In a preferred embodiment, an image search and display system is provided. It can create groups automatically, and allow a user to designate names to each group. Alternatively, the system provides a configuration in which the grouping is made based on the people who appear the most often in a single representative picture, and thus the user can easily see which group includes this set of most frequently photographed people. FIG. 5 shows two groups, with one person appearing in both groups, e.g., the owner of the photos. If the group on the left is the owner's families and the group on the right is the owner's colleagues, then it is very easy for the owner to see the meaning of the groups. Furthermore, the number of pictures in the group is used to determine the size that the group is displayed. In FIG. 5, the group on the left is bigger because it contains more pictures than the group on the right. A user can intuitively select one of the groups to open that group of pictures by clicking the thumbnail shown with distorted images of people in the group. Thumbnails for subgroup within a group can be flexibly created such that a user is provided with further options to conveniently search and view different pictures by simply clicking different thumbnails of images shown with images of different persons.

In an alternate preferred embodiment, all the thumbnails relating to the information of different set of images are displayed on a single screen, so a scroll-bar will be necessary for browsing all the thumbnails. A user may zoom-in to view the details of different thumbnails but the relative sizes of all elements are kept same. The search and display system may be implemented on systems with touch-screen display, and therefore the user can circle to select the corresponding areas on the touch screen for the selected parts. A user can easily search and navigate the images by simply and intuitively touching on the different parts of the screen display according to the intended location, time and people. This provides a very easy and intuitive way for the user to search and find a specific picture in a large collection of pictures.

The user interface of this system highlights the locations, times and people with the most pictures. Of course this system can also be used to find the locations, times and people with only a small number of pictures. From the location and time tags, the user can easily see the locations and time with few pictures. Similarly, on the people tag, the user can quickly see the people who appear in only a few pictures (thumbnails having smallest size). The system could provide an option to the user to invert the presentation to highlight the locations, times and people with the fewest pictures so the user can easily find the rare pictures in their large collection of pictures.

In a preferred embodiment, the image search and display system includes a meta data processor for processing the digital images tagged with meta data containing information related to location, time and names of people. The image search and display system further includes a map, which includes locations corresponding to the meta data tagged to each digital picture. The image search and display system according to this invention processes the meta data of each image and establishes a table, e.g., a database, for associating each picture by means of location, time and people. The system analyzes the location information for a set of pictures and cluster pictures taken near the same location (e.g. define a 5 mile radius and cluster the pictures within 5 miles, and combine the overlapping regions into a single cluster). Next, the system maps the clusters onto intervals I1, . . . In, based on the number of pictures in each interval, where In includes the locations with the most pictures. A magnification factor is assigned to each interval with M(I1)=0 and M(In)=Maximum. Based on these magnification values, the map can be displayed with the locations in each interval magnified to the corresponding factor. For a preferred embodiment, the magnified parts may cover other parts of the map (so these parts appear squeezed) but because these other parts have no pictures, they do not affect the navigation through this collection of pictures. In practical implementation, for the pictures taken outside the map area, the locations can be displayed on one side of the map on the background. For example, FIG. 2 shows a map of China, if there were also the pictures taken in Japan but the map does not cover Japan, the locations would be indicated on an area on the side of the map in the direction of Japan. Thus the user has an approximate idea where the photos were taken even though the map doesn't cover this location. In general it is expected that the map will cover the locations where the user usually takes pictures and so the pictures outside the map will be a minority. Similarly, for the searching through the timeline, the system will analyze the number of pictures taken during each time period and magnify the timeline accordingly. For searching the pictures through identification of different persons, the system can simply count the number of occurrences of each person in the photo collection and then assign the people to intervals, and based on the intervals, assign magnification values to the thumbnails (up to some maximum value). According to the embodiments above described, the invention discloses an image search and display system, which comprises an image classifying and processing means for classifying a plurality of images based on contents of the images and circumstances in forming the images.

Although the present invention has been described in terms of the presently preferred embodiments, it is to be understood that such disclosure is not to be interpreted as limiting the scope of the invention. Various alternations and modifications will no doubt become apparent to those skilled in the art after reading the above disclosure. Accordingly, it is intended that the appended claims be interpreted as covering all alternations and modifications as falling within the true spirit and scope of the invention.

1. An image search and display system for processing a plurality of images tagged with data related to contents of said images and circumstances in forming said images, comprising:
a graphic user interface for displaying a user-selectable graphic element for displaying a tag graph relating to said contents of said images and said circumstances in forming said images to link to related images to be searched.

2. The image search and display system of claim 1, wherein said user-selectable graphic element provides a link to a location where said image is taken.

3. The image search and display system of claim 1, wherein said user-selectable graphic element provides a link to a time when said images are taken.

4. The image search and display system of claim 1, wherein said user-selectable graphic element provides a link to a person included in said contents of said image.

5. The image search and display system of claim 1, wherein said user-selectable graphic element comprises a map with a portion of a location for linking to said location where said images are taken.

6. The image search and display system of claim 1, wherein said user-selectable graphic element comprises a time-line with a time point indication for linking to said time point when said images are taken.

7. The image search and display system of claim 1, wherein said user-selectable graphic element comprises an image of a person for linking to the person included in said contents of said images.

8. The image search and display system of claim 1, wherein said user-selectable graphic element comprises a map with a plurality of magnified portions at a plurality of locations on said map, the magnification ratio of which corresponding to the number of the images at each of said locations for linking to said location where said images are taken.

9. The image search and display system of claim 1, wherein said user-selectable graphic element comprises a time-line with a plurality of time indication points on said time line, the length between said time indication points corresponding to the number of the images taken during a time period between said time point indications for linking to said time when said images are taken.

10. The image search and display system of claim 1, wherein said user-selectable graphic element comprises a plurality of images each showing a person for linking to the person included in said contents of said images, wherein each of said images is magnified with a magnification ratio proportional to the number of the pictures including said images of that person.

11. The image search and display system of claim 1, wherein said user-selectable graphic element comprises a plurality of images each showing a group of people for linking to said group of persons included in said contents of said images, wherein each of said images is magnified with a magnification ratio proportional to the number of the pictures including images of persons from said group of people.

12. The image search and display system of claim 1, wherein said user-selectable graphic element comprises a map with a plurality of colors at a plurality of locations on said map, the colors displayed on the images corresponding to the number of the images taken at each of said locations for linking to said locations where said images are taken.

13. The image search and display system of claim 1, wherein said user-selectable graphic element comprises a time-line with a plurality of time indication points, each color displayed between said time indication points corresponding to the number of the images taken between said time indication points for linking to said times when said images are taken.

14. The image search and display system of claim 1, wherein said user-selectable graphic element comprises a plurality of images each showing a person for linking to said person included in said contents of said images, wherein the colors of said user-selectable graphic element correspond to the number of said images including that person.

15. The image search and display system of claim 1, wherein said user-selectable graphic element comprises a map with a plurality of brightness values displayed at a plurality of locations, each of said brightness values corresponding to the number of the images taken at each of said locations for linking to said locations where said images are taken.

16. The image search and display system of claim 1, wherein said user-selectable graphic element comprises a time-line with a plurality of time indication points on said time-line, and the periods between said indication points are displayed in different brightness values according to the number of the images taken during said periods for linking to said images which are taken during said periods.

17. The image search and display system of claim 1, wherein said user-selectable graphic element comprises a plurality of images for linking to a person included in said contents of said images, and according to the number of said images including that person, each of said images is displayed in different brightness values.

18. The image search and display system of claim 1, further comprising:
image classifying and processing means for classifying said plurality of images based on said contents of said images and said circumstances in forming said images.

19. An image search and display method, comprising the steps of:
processing a plurality of images attached with meta data, wherein the meta data carry contents of said images and circumstances in forming said images; and
displaying a user-selectable image graphic element, wherein said user-selectable image graphic element displays said contents of said image and said circumstances in forming said images for linking to related images to be searched.

20. The method of claim 19, wherein displaying the user-selectable graphic element further comprises displaying and providing a link to a location where said image is taken.

21. The method of claim 19, wherein displaying the user-selectable graphic element further comprises displaying and providing a link to a time when said image is taken.

22. The method of claim 19, wherein displaying the user-selectable graphic element further comprises displaying and providing a link to a person included in said contents of said image.
